(19) United States
(12) Patent Application Publication
(10) Pub. No.: US 2014/0318224 A1
(43) Pub. Date: Oct. 30, 2014

(54) HIGH-PRESSURE CONSTANT FLOW RATE PUMP AND HIGH-PRESSURE CONSTANT FLOW RATE LIQUID TRANSFER METHOD

(71) Applicant: Hitachi High-Technologies Corporation, Tokyo (JP)

(72) Inventors: Yugo ONODA, Tokyo (JP); Daisuke AKIEDA, Tokyo (JP); Hiroyuki WADA, Tokyo (JP); Toyoaki TANOUE, Tokyo (JP); Mitsuhiko UEDA, Tokyo (JP); Takashi YAGI, Tokyo (JP)

(73) Assignee: Hitachi High-Technologies Corporation, Tokyo (JP)

(21) Appl. No.: 14/255,458

(22) Filed: Apr. 17, 2014

(30) Foreign Application Priority Data
Apr. 24, 2013 (JP) 2013-091576

(51) Int. Cl. F04B 49/06; F04B 49/03; G01N 30/28; F04B 41/06

(52) U.S. Cl. CPC F04B 49/065; F04B 41/06; F04B 49/03; G01N 30/28
USPC 73/61.56; 137/565.15

(57) ABSTRACT

A high-pressure constant flow rate pump transfers a solvent from a low-pressure side liquid transfer system even if a difference between mixing ratios is large when solvents are mixed during high-pressure gradient liquid transfer. A pressure detection value from a second pressure sensor and a pressure detection value from a fourth pressure sensor are compared with each other. If the pressure detection value P_{A1} of the second pressure sensor is equal to or greater than the pressure detection value P_{A2} of the fourth pressure sensor, a second check valve comes into an opened state and operation is ended. If P_{A1} is less P_{A2}, leakage determination is implemented. If it is determined that no leakage occurs, the type of the solvent is identified. A compression distance of a second plunger which is determined for each solvent and stored in a memory is added and the first plunger is driven.

### BACKGROUND OF THE INVENTION

1. Field of the Invention

The present invention relates to a high-pressure constant flow rate pump used in a high-speed liquid chromatograph.

2. Description of the Related Art

Some liquid chromatographs implement gradient liquid transfer to transfer solvents. To implement the gradient liquid transfer, the liquid chromatograph has two liquid transfer systems and controls their corresponding liquid transfer pressures so as to temporally change a mixing ratio of a plurality of types of solvents, in a mobile phase, transferred to an analyzing section.

JP-T-2008-500556 describes equipment that allows liquid to flow in nL/min order without complicated correction in a mixing ratio of solvents during the gradient liquid transfer.

More specifically, JP-T-2008-500556 describes the technology in which fluids (solvents) from two pumps are joined together and the respective flow rates of the two pumps are controlled so that a fluid may flow at a low flow rate corresponding to a difference in pressure between the two pumps.

### SUMMARY OF THE INVENTION

For the above-mentioned gradient liquid transfer, the two liquid transfer systems are provided with respective check valves to prevent backflow on respective output sides.

In a state where a difference in the mixing ratios between the solvents transferred from the two respective liquid transfer systems is small, the check valves of the liquid transfer systems are both in an opened state. However, if a difference in mixing ratios between the solvents transferred from the respective liquid transfer systems becomes large, the check valve on the side where the mixing ratio of the solvent is small may not assume an opened state. In other words, there is a possibility that mixing at a desired ratio cannot be implemented when a difference in ratio of solvents is large.

In this case, solvents cannot be mixed with each other with a high degree of accuracy. To eliminate such a disadvantage, it is conceivable that a drive mechanism for a check valve is provided on the liquid transfer system on the side where the mixing ratio of the solvent is small, and is controlled to forcibly bring the check valve into the opened state. However, the configuration becomes complicated and also costs increase; therefore, the provision of the drive mechanism for the check valve is not preferable.

It is considered that the conventional technology does not recognize that if a difference in mixing ratio between the solvents transferred from the two respective liquid transfer systems becomes large, the check valve on the side where the mixing ratio of the solvent is small may not assume an opened state in some cases, and also its disclosure is not made. As a result, effective measures against such a disadvantage have not been taken.

It is an object of the present invention to provide a high-pressure constant flow rate pump and a high-pressure constant flow rate liquid transfer method that can reliably transfer a solvent from a liquid transfer system on the side where a mixing ratio is small even if a difference in mixing ratio between solvents is large when the solvents are mixed with each other during high-pressure gradient liquid transfer.

To achieve the above object, the present invention is constituted as below.

According to one aspect of the present invention, there is provided a high-pressure constant flow rate pump comprising: a first pump for discharging a first solvent; a second pump for discharging a second solvent; a mixer for mixing the first solvent discharged from the first pump with the second solvent discharged from the second pump and transferring the mixed solvent; a first pressure sensor disposed in a passage between the first pump and the mixer, the first pressure sensor detecting a pressure of the first solvent discharged from the first pump; a first check valve disposed in a passage between the first pressure sensor and the mixer; a second pressure sensor disposed in a passage between the second pump and the mixer, the second pressure sensor detecting a pressure of the second solvent discharged from the second pump; a second check valve disposed between the second pressure sensor and the mixer; and a control section.

The control section controls a discharge amount of the first solvent from the first pump and a discharge amount of the second solvent from the second pump and changes a mixing ratio of the first solvent and the second solvent in the mixer. The control section determines whether the first check valve is in an opened or closed state on the basis of a pressure, among others, detected by the first pressure sensor, and if the first check valve is in the closed state, the control section increases the discharge pressure of the first pump to bring the first check valve into the opened state. The control section also determines whether the second check valve is in an opened or closed state on the basis of a pressure, among others, detected by the second pressure sensor, and if the second check valve is in the closed state, the control section increases the discharge pressure of the second pump to bring the second check valve into the opened state.

According to another aspect of the present invention, there is provided a high-pressure constant flow rate liquid transfer method comprising the steps of: discharging a first solvent from a first pump to a mixer via a first pressure sensor and a first check valve, and discharging a second solvent from a second pump to the mixer via a second pressure sensor and a second check valve; and controlling a discharge amount of the first solvent from the first pump and a discharge amount of the second solvent from the second pump to change a mixing ratio of the first solvent and the second solvent in the mixer. The method further comprises the steps of determining whether the first check valve is in an opened or closed state on the basis of a pressure, among others, detected by the first pressure sensor; increasing the discharge pressure of the first pump to bring the first check valve into the opened state if the first check valve is in the closed state; determining whether the second check valve is in an opened or closed state on the basis of a pressure, among others, detected by the second pressure sensor; and increasing the discharge pressure of the second pump to bring the second check valve into the opened state if the second check valve is in the closed state.

The high-pressure constant flow rate pump and the high-pressure constant flow rate liquid transfer method are provided that can reliably transfer a solvent from a liquid transfer system on the side where a mixing ratio is small even if a difference between mixing ratios is large when solvents are mixed during high-pressure gradient liquid transfer.

### BRIEF DESCRIPTION OF THE DRAWINGS

FIG. 1 is an explanatory diagram showing the configuration of a liquid transfer device which is a high-pressure constant flow rate pump according to a first embodiment of the present invention.

FIG. 2 is an operation flowchart of a pre-compression process encountered when a first plunger is moved in a compression direction.

FIG. 3 is a functional block diagram of an essential portion of a data processing unit.

FIG. 4 is a graph showing the relationship between the transfer pressures and the number of compression pulses of solvents.

FIG. 5 is a graph showing experimental results when only the value of a fourth pressure sensor is used for control while changing the mixing ratios of solvents transferred from associated liquid transfer systems.

FIG. 6 is a graph showing pressure-related results when the action of a second plunger or a first plunger is controlled so that a pressure value at the time of the end of compression may be equal to the detected pressure of the fourth pressure sensor or a third pressure sensor.

FIG. 7 is an operation flowchart for changing a feedback coefficient according to a second embodiment.

FIG. 8 is a schematic configurational diagram of an overall liquid chromatograph which embodies the present invention.

Preferred embodiments of the present invention will be described herein below with reference to the accompanying drawings. In the following embodiments, the high-pressure constant flow rate pump of the present invention is applied to a liquid chromatograph.

### DESCRIPTION OF THE PREFERRED EMBODIMENTS

### First Embodiment

A description will first be given of the entire configuration of a liquid chromatograph according to a first embodiment of the present invention.

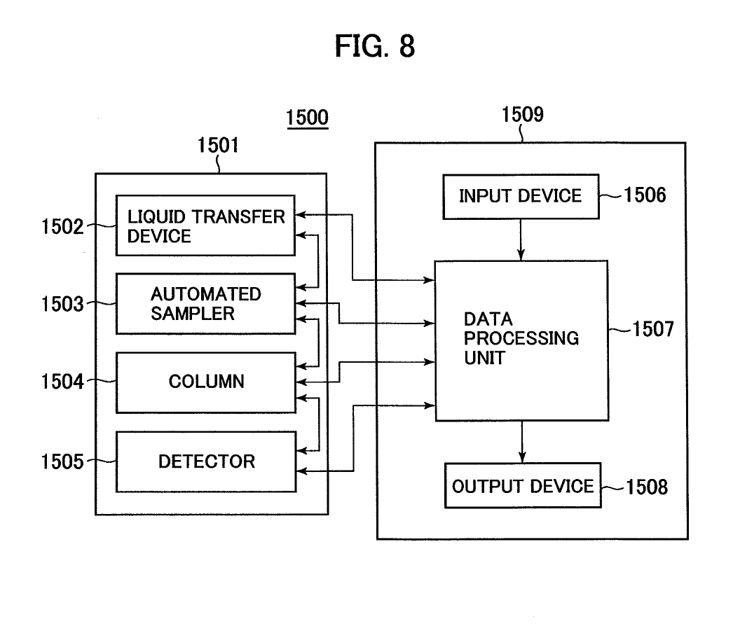

FIG. 8 is a schematic configuration diagram of a liquid chromatograph. In FIG. 8, the liquid chromatograph 1500 includes a liquid chromatographic section 1501 which performs separation and analysis on mixed samples, and a control section 1509 which exercises control on constituent sections of the liquid chromatographic section 1501.

The liquid chromatographic section 1501 includes a liquid transfer device (a liquid transfer section) 1502 which transfers solvents on the basis of a command from a data processing unit 1507 of the control section 1509; an automated sampler (a sample pouring section) 1503 which pours a sample into the solvent transferred from the liquid transfer device 1502 on the basis of a command from the control section 1509; a separation column (a separating section) 1504 which separates a component from the sample transferred from the automatic sampler 1503; and a detector (a detecting section) 1505 which detects the component separated by the separating column 1504, converts the detected component into an electric signal, and outputs the electric signal to the data processing unit 1507 of the control section 1509.

The control section 1509 includes the data processing unit 1507 which executes the exchange of commands and data with various devices relating to the liquid chromatographic section 1501 and controls the operation of the various devices; an input device 1506 which receives instructions and the like from an operator; and an output device 1508 which indicates the detection results of the detector 1505 and a graphical user interface (GUI) and the like relating to various operations of the liquid chromatographic section 1501 and the control section 1509.

The measurement values of the components detected by the detector 1505 are taken in the data processing unit 1507. The analysis results of a sample are sent to the output device (the display section) 1508 for indication.

A high-pressure constant flow rate pump in the first embodiment of the present invention corresponds to the liquid transfer section 1502 shown in FIG. 8.

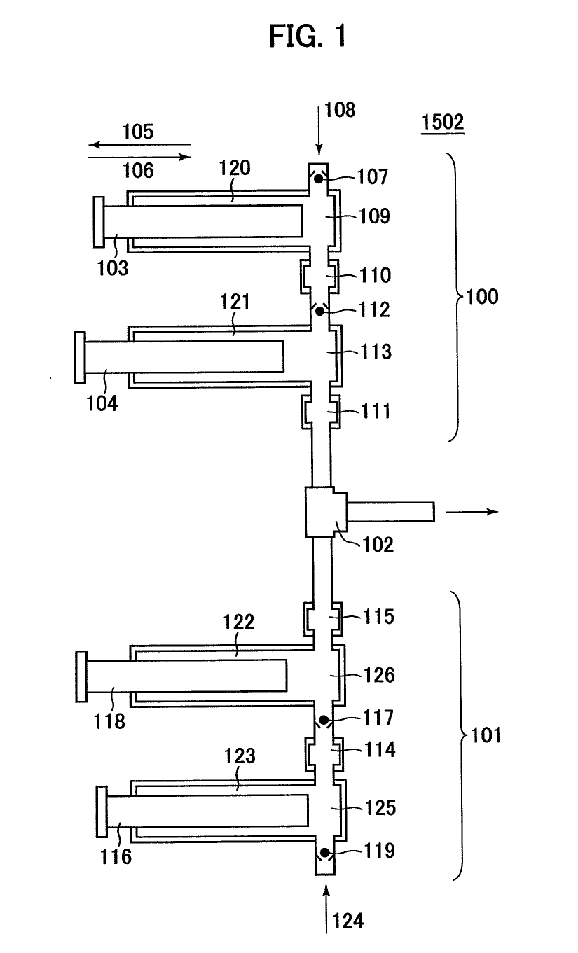

FIG. 1 is an explanatory view illustrating the configuration of the liquid transfer section 1502, which is a high-pressure constant flow rate pump, according to the first embodiment of the present invention.

Referring to FIG. 1, the liquid transfer device 152 includes an A-pump 100 and a B-pump 101. Solvent delivered from the A-pump 100 and solvent delivered from the B-pump 101 are joined together and mixed in a mixing device (a mixer) 102.

The A-pump 100 includes a first cylinder 120; a first plunger 103 reciprocated in the first cylinder 120; a third cylinder 121; a third plunger 104 reciprocated in the third cylinder 121; a solvent inlet port 108; and a third check valve (a non-return valve) 107 disposed at the solvent inlet port 108. In a pre-compression process, if the first plunger 103 moves in a solvent suction direction 105, the third check valve 107 opens to suck liquid (a first solvent) with atmospheric pressure from the solvent inlet port 108. Thus, the first chamber 109 in the first cylinder 120 is filled with the liquid with atmospheric pressure.

After the first chamber 109 has been filled with the liquid with atmospheric pressure, if the first plunger 103 moves in a compression direction 106, the first solvent thus poured is compressed. The first cylinder 120 has a first pressure sensor 110 disposed between the first cylinder 120 and the third cylinder 121 to measure the pressure in the first cylinder 120. The first pressure sensor 110 measures how much the inside of the first cylinder 120 is compressed.

A first check valve (a non-return valve) 112 is disposed between the first pressure sensor 110 and the third cylinder 121. A third pressure sensor 111 is disposed between the third cylinder 121 and the mixing device 102. When a pressure detection value P_{A1} of the first pressure sensor 110 is greater than a pressure detection value P_{A2} of the third pressure sensor 111, the first check valve 112 opens, so that the third chamber 113 of the third cylinder 121 is filled with the compressed solvent.

Also the B-pump 101 has the same configuration as the A-pump 100. Specifically, the B-pump 101 includes a second cylinder 123; a second plunger 116 reciprocated in the second cylinder 123; a fourth cylinder 122; a fourth plunger 118 reciprocated in the fourth cylinder 122; a solvent inlet port 124: and a fourth check valve (a non-return valve) 119 disposed at the solvent inlet port 124. If the second plunger 116 moves in a solvent suction direction 105, the check valve 119 opens to suck liquid (a second solvent) with atmospheric pressure from the solvent inlet port 124, so that the second chamber 125 in the second cylinder 123 is filled with liquid with atmospheric pressure.

After the second chamber 125 has been filled with liquid with atmospheric pressure, if the second plunger 116 moves in the compression direction 106, the second solvent thus poured is compressed. The second cylinder 123 has a second pressure sensor 114 disposed between the second cylinder 123 and the fourth cylinder 122 to measure the pressure in the second cylinder 123. The second pressure sensor 114 measures how much the inside of the second cylinder 123 is compressed.

A second check valve (a non-return valve) 117 is disposed between the second pressure sensor 114 and the fourth cylinder 122. A fourth pressure sensor 115 is disposed between the fourth cylinder 122 and the mixing device 102. When a pressure detection value P_{A1} of the second pressure sensor 114 is greater than a pressure detection value P_{A2} of the fourth pressure sensor 115, the second check valve 117 opens, so that the fourth chamber 126 of the fourth cylinder 122 is filled with the compressed solvent.

The first and second solvents compressed as described above are mixed in the mixing device 102 at an arbitrary mixing ratio with a flow rate from the A-pump 100 and a flow rate from the B-pump 101.

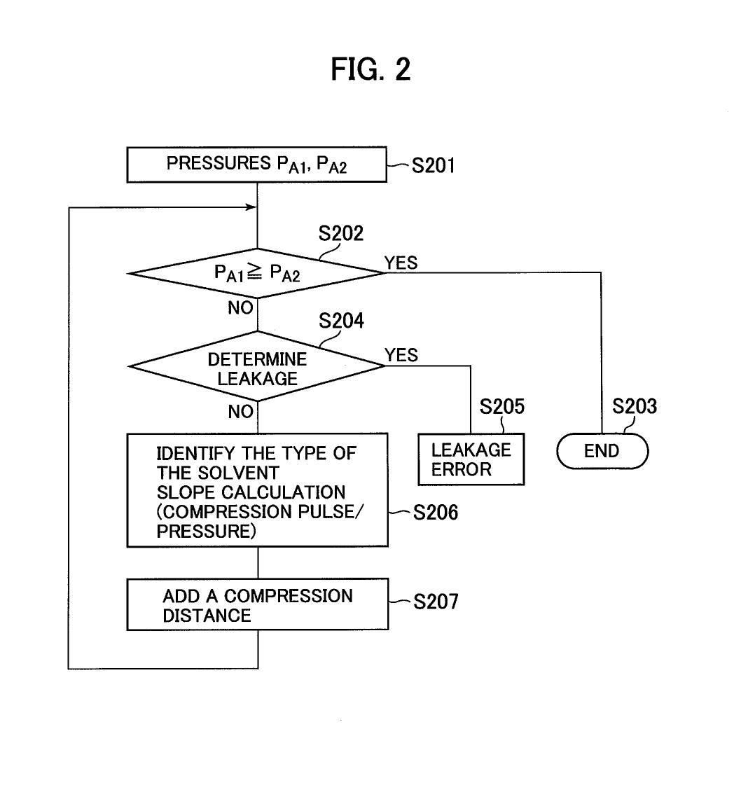

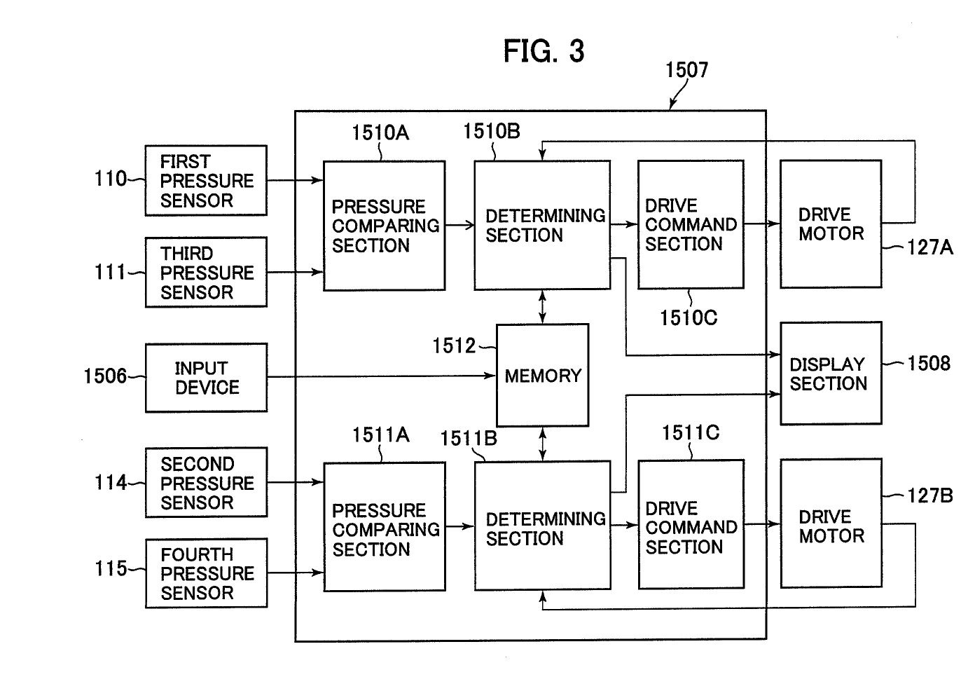

FIG. 2 is an operation flowchart for the data processing unit 1507 during the pre-compression process in which the first plunger 103 is moving in the compression direction 106. FIG. 3 is a function block diagram of an essential portion of the data processing unit 1507. In FIG. 3, the data processing unit 1507 includes pressure comparing sections 1510A, 1511A, determining sections 1510B, 1511B, drive command sections 1510C, 1511C, and a memory 1512.

The operation flow of the data processing unit 1507 is next described with reference to FIGS. 2 and 3.

The data processing unit 1507 receives a pressure detection value from the second pressure sensor 114 and a pressure detection value from the fourth pressure sensor 115 (step S201). The pressure comparing section 1511A compares the pressure detection values with each other. The determining section 1511B determines whether or not the pressure detection value P_{A1} of the second pressure sensor 114 is equal to or greater than the pressure detection value P_{A2} of the fourth pressure sensor 115 (step S202). In step S202, if the pressure detection value P_{A1} is equal to or greater than the pressure detection value P_{A2}, the second check valve 117 comes into the opened state and then the operation of the data processing unit 1507 is ended (step S203).

In step S202, if the pressure detection value PA1 is less than the pressure detection value PA2, the operation proceeds to step S204, in which the determining section 1511B performs the determination of leakage. During the pre-compression, the second pressure sensor 114 is used to measure the pressed-into distance of the second plunger 116 and a pressure-rise value at that time. This allows for the determination of leakage, that is, it is possible to determine whether or not the second solvent leaks from the B-pump 101. This is because if the leakage is occurring, then the pressure will not rise although the second solvent is pressed into by the second plunger 116. If it is considered that the leakage is occurring, the determining section 1511B outputs a command to the display section 1508 to indicate the occurrence of the leakage for the indication of a leakage error. Then, the operation gets out of the loop (step S205).

In step S204, if the determining section 1511B determines that the leakage is not occurring, the operation proceeds to step S206, in which the solvent is identified.

It is possible to identify the type of the solvent from the compression distance (the driving amount) of the second plunger 116 pressed into and from a rise in the pressure value detected by the second pressure sensor 114 during the pre-compression. Different solvents or solvents having different compositions are followed by different volume elastic coefficients. Thus, it is possible to identify the type of the solvent by calculating its volume elastic coefficient.

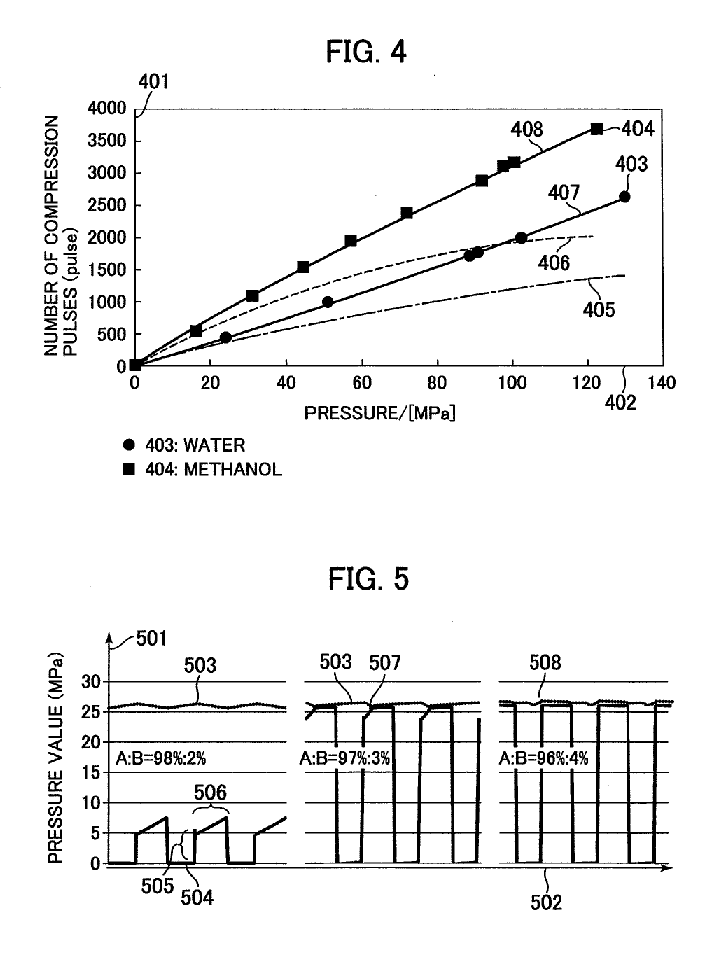

How to obtain the volume elastic coefficient of a solvent is here described with reference to FIG. 4.

FIG. 4 is a graph showing the relationship between the transfer pressure and the number of compression pulses of each of solvents. In FIG. 4, a longitudinal axis 401 represents the number of compression axis and a horizontal axis represents pressure. The numbers of compression pulses required when water is compressed as a solvent are plotted as shown by black circles 403. On the other hand, the numbers of compression pulses required when methanol is compressed as a solvent are plotted as shown by black squares 404.

Using volume elastic coefficients, which are physical property values of water and methanol, results obtained from calculation based on the following equation (1), which is a definitional equation of a volume elastic coefficient, shall be plotted as shown by dotted lines 405 (water) and 406 (methanol).

ΔV=(ΔP/K)·V (1)

Incidentally, in the above equation, symbol V represents a volume at atmospheric pressure, ΔV represents a volume variation, ΔP represents a pressure variation, and K represents a volume elastic coefficient.

The volume elastic coefficient K obtained from the above equation (1) is not a value possessed by a solvent per se but a numerical value of the overall system. Therefore, the black circles 403 and the black squares 404 which represent experimental results do not conform to the values 405 and 406, respectively, obtained from the above equation (1).

With that, to allow the values obtained from the equation (1) to conform to the respective experimental results with using the volume elastic coefficients as physical property values, a function after the introduction of correction is given as g(ΔP). A function f(ΔP) before the introduction of correction is given as the following equation (2).

ΔV=(ΔP/K)·V=f(ΔP) (2)

In addition, the function g(ΔP) after the introduction of correction is given as the following equation (3).

ΔV=g(ΔP) (3)

The following equation (4) is here shown as one example of the function g(ΔP) after the introduction of correction.

ΔV=g(ΔP)=(ΔP/K)(V+aΔP) (4)

However, the function g(ΔP) after the correction is not always limited to the above equation (4) but may be polynomial approximation of ΔP as shown in, for example, the following equation (5). Here, symbols a, b, c and n represent constants of real numbers.

ΔV=g(ΔP)=(ΔP/K)(V+aΔP+bΔP²+cΔP³+ . . . +nΔPⁿ) (5)

Alternatively, also the volume elastic coefficient K is the function of pressure ΔP; therefore, it may be taken in the correction function g(ΔP) as shown in the following equation (6).

K=K(ΔP)=K(1+a′ΔP+b′ΔP²+c′ΔP³+ . . . +n′ΔPⁿ) (6).

Here, symbols a′, b′, c′ and n′ represent constants of real numbers.

It is considered that with increasing pressure the original volume V is increased by a proportionality factor “a”. It also may be considered that leakage is occurring. Because of using the correction function, the curve line 408 of methanol and the curve line 407 of water are made to conform to the respective experimental results. In this way, the correction function g(ΔP) can be used to derive the volume elastic coefficients of also solvents other than water and methanol on the basis of the one-push action of the plunger.

If the number of compression pulses with respect to the pressure in FIG. 4 is largely increased due to a large amount of leakage or bubbles, it is determined in the step of leakage determination in FIG. 2 that an error occurs due to leakage or mixing-in of bubbles.

As described above, the determining section 1511B obtains the volume elastic coefficient and identifies the type of the solvent. Then, the determining section 1511B adds the compression distance (the driving amount) which is previously stored in the memory 1512 and which is determined for each solvent and gives a drive command to the drive command section 1511C (step S207). The operation returns to step S202. The drive command section 1511C outputs a drive command to a drive motor 127B which drives the second plunger 116. The operation amount and operation position of the drive motor 127B are detected by the determining section 1511B.

As long as the value P_{A1} of the second pressure sensor 114 is smaller than the value P_{A2} of the fourth pressure sensor 115, the loop continues until the value P_{A1} of the second pressure sensor 114 becomes greater than the value P_{A2} of the fourth pressure sensor 115 with increasing the compression distance.

The above description of the operation flow relates to the B-pump 101. However, for also the A-pump 100, the pressure sensors correspond to the first pressure sensor 110 and the third pressure sensor 111. In addition, the similar control action is implemented using the pressure comparing section 1510A, the determining section 1510B, the drive command section 1510C, and the drive motor 127A.

FIG. 5 is a graph showing experimental results obtained when control is exercised as below. When the A-pump 100 and the B-pump 101 are used to mix solvents, the control is exercised using only the value of the fourth pressure sensor 115 while changing a mixing ratio of respective solvents transferred from the A-pump 100 and the B-pump 101. In FIG. 5, a longitudinal axis 501 represents a pressure value and a horizontal axis 502 represents time.

The value of the fourth pressure sensor 115 of the B-pump 101 is denoted by a dotted line 503. The value of the second pressure sensor 114 of the B-pump 101 is denoted by a solid line 504.

If the mixing ratio of the solvent transferred from the B-pump 101 is 2%, the value 504 of the second pressure sensor 114 does not reach the value 503 of the fourth pressure sensor 115 even after the compression process 505. In addition, also in a process 506 in which the second plunger 116 of the B-pump 101 transfers the solvent, although the value 504 of the second pressure sensor 114 is increased, it does not reach the value 503 of the fourth pressure sensor 115.

If the mixing ratio of the solvent transferred from the B-pump 101 is 3%, the value of the second pressure sensor 114 does not reach the value 503 of the fourth sensor 115 in the compression process. However, in the liquid transfer process, the pressure of the second pressure sensor 114 reaches the value 503 of the fourth pressure sensor 115 (pressure 507) and it can be determined that the second check valve 117 is opened.

If the mixing ratio of the solvent transferred from the B-pump 101 is 4%, the value 504 of the second pressure sensor 114 reaches the value 503 of the fourth pressure sensor 115 (pressure 508) in the compression process and it can be determined that the second check valve 117 is opened.

As shown in the experimental results of FIG. 5, if the solvents are to be mixed in the high-pressure gradient liquid transfer process, the second check valve 117 or the first check valve 112 for a solvent with a small mixing ratio is to be opened. To that end, it is necessary to observe the pressure values of the second pressure sensor 114 and the first pressure sensor 110, or the pressure values of the fourth pressure sensor 115 and the third pressure sensor 111.

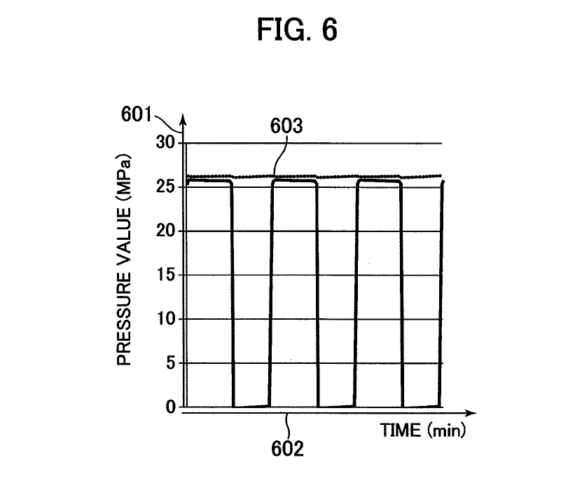

FIG. 6 is a graph showing pressure-related results obtained when the action of the second plunger 116 is controlled so that the pressure value of the second pressure sensor 114 at the time of the end of the compression may be equal to that of the fourth pressure sensor 114 or when the action of the first plunger 103 is controlled so that the pressure value of the first pressure sensor 110 at the time of the end of the compression may be equal to that of the third pressure sensor 111. In FIG. 6, a longitudinal axis 601 represents a pressure value and a horizontal axis 602 represents time. The experimental condition by which the pressure values shown in FIG. 6 are obtained is such that the mixing ratio of the solvent transferred from the B-pump 101 is 1%. As shown in FIG. 6, even when the mixing ratio is small, the pressure when the compression is ended reaches the detected pressure value of the fourth pressure sensor 115 (pressure 603). Thus, it can be confirmed that the pre-compression can be done properly.

That is to say, the data processing unit 1507 executes steps S202, S204, S206, and S207 in FIG. 2 to control the action of the second plunger 116 so that the detected pressure values of the second pressure sensor 114 and the fourth pressure sensor 115 may be equal to each other. In this way, even when the mixing ratio is small, the second check valve 117 can be brought into an opened state. Similarly, the operation of the first plunger 103 is controlled so that the detected pressure values of the first pressure sensor 110 and the third pressure sensor 111 may be equal to each other. In this way, the first check valve 112 can be brought into an opened state even at a low flow ratio.

The above description shows the example in which the detected pressure values of the second pressure sensor 114 and the fourth pressure sensor 115 are made equal to each other and the detected pressure values of the first pressure sensor 110 and the third pressure sensor 111 are made equal to each other. However, also the action of the second plunger 116 can be controlled so that the detected pressure value of the second pressure sensor 114 may be greater than the detected pressure value of the fourth pressure sensor 115 in a predetermined range (e.g. 0.3 MPa). Similarly, the action of the first plunger 103 can be controlled so that the detected pressure value of the first pressure sensor 110 may be greater than the detected pressure value of the third pressure sensor 111 in a predetermined range (e.g. 0.3 MPa).

Since such detected pressure values are controlled within the above range, while preventing the problems with pressure pulsation and degradation of flow accuracy caused by overshoot resulting from excessive compression, the second check valve 117 and the first check valve 112 can reliably be brought into the opened state.

Thus, the liquid chromatograph can be provided which uses the high-pressure constant flow rate pump that can reliably transfer the solvent from the liquid transfer system on the small mixing ratio side even if a difference in mixing ratio of solvents is large when the solvents are mixed in the high-pressure gradient liquid transfer. Also the high-pressure constant flow rate liquid transfer method for the liquid chromatograph can be implemented.

### Second Embodiment

A description is next given of a second embodiment of the present invention.

The first embodiment described above is an example in which the first pressure sensor 110 and the second pressure sensor 114 are provided and the associated check valves are opened to properly perform the pre-compression.

In FIG. 5, the proper pre-compression can be done by also the control in which only the fourth pressure sensor 115 is used for measurement from the case where the mixing ratio of the solvent transferred from the B-pump 101 is set at 4%. Therefore, gradient liquid transfer can be done. In this way, if the operation of the first plunger 103 or the third plunger 104 is controlled in the case where the mixing ratio of one of the solvents is equal to 4% or more, the first check valve 112 or the second check valve 117 can be brought into the opened state.

In the second embodiment of the present invention, when an arbitrary mixing ratio is set at e.g. lower than 10% in the case where the lower side mixing ratio is equal to 4% or greater, control is exercised as below. A feedback coefficient is set at a value greater than the usual one to increase the compression distance, whereby the check valve is reliably brought into an opened state.

A description is here given of the feedback coefficient in the second embodiment of the present invention.

Because of transferring a high-pressurized solvent, a pump used in a high-pressure chromatograph is such that control in a compression process is important. If compression is deficient, solvent cannot be high-pressurized, so the liquid transfer pressure causes an undershoot at the end of the compression. On the other hand, if compression is excessive, the liquid transfer pressure causes an overshoot at the end of the compression. Especially for the liquid chromatograph, the overshoot is undesirable because it is likely to degrade or break the column.

Therefore, to reduce pressure pulsation, the control of the compression distance, i.e., of the number of compression pulses becomes important.

In the present embodiment, proportional control is exercised as below. Liquid transfer pressure at an intermediate point where an influence resulting from the liquid transfer of only the third plunger 104 is smallest, or at a predetermined point after such an intermediate point, is assumed as a reference liquid transfer pressure. A deviation, which is a difference between this reference liquid transfer pressure and a pressure at the time of the end of compression, is multiplied by a proportional coefficient. Then, the value thus obtained is fed back to the compression distance of the next cycle.

If it is assumed that the compression distance is ΔL, the reference liquid transfer pressure is p, and the pressure value of the first pressure sensor 110 is pi (i=1, 2, 3, . . . ), a compression distance ΔL_{old} at the current cycle is replaced with (i.e., fed back to) a compression distance ΔL_{new} at the next cycle by the proportional control.

The relationship among the above-mentioned symbols p, pi, ΔLold and ΔLnew is represented by the following equation (5).

ΔLnew=ΔLold−kₚΣ(pi−p) (5)

In the above equation (5), symbol kₚ represents a proportional coefficient, which can be determined as a value as large as possible from an experimental value under the condition that no overshoot occurs until a stable state is reached from the time when the drive of the pump is started.

When an overshoot is caused due to excessive compression, that is, when Σ(pᵢ−p) is a positive value, [−kₚΣ(pᵢ−p)], which is a term of feedback in the above equation (5), is positive. Thus, the feedback control is excised to reduce the overshoot.

On the other hand, when the compression is deficient (when the undershoot is caused), that is, when Σ(pᵢ−p) is a negative value, [−kₚΣ(pᵢ−p)], which is a term of feedback, is negative. Thus, the feedback control is exercised to reduce the undershoot.

Incidentally, when the deviation (pᵢ−p) is large, also the value thus fed back is large. When the deviation is small, the value thus feedback is small.

In this way, the proportional control is exercised. The number of compression pulses which will be used at the next cycle is feedback-controlled. This can finally make the reference liquid transfer pressure and the pressure value at the time of the end of compression equal to each other.

In the second embodiment of the present invention, the above-mentioned feedback coefficient kₚ is changed depending on the case where the value of the mixing ratio of one of solvents is less than 10% and the case where it is equal to or greater than 10%. The feedback coefficient kₚ (the first proportional coefficient) in the case of 10% or more is determined as a value as large as possible from the experimental value under the condition that no overshoot is caused until the stable state is reached from the time when the drive of the pump is started as described above. The feedback coefficient kₚ (the second proportional coefficient) in the case of less than 10% is greater than the feedback coefficient in the case of 10% or more. Even if the mixing ratio of one of the solvents is small (e.g. in the case of 1%), a value of the kₚ can previously be determined by an experiment so that the first check valve 112 and the second check valve 117 will be reliably opened.

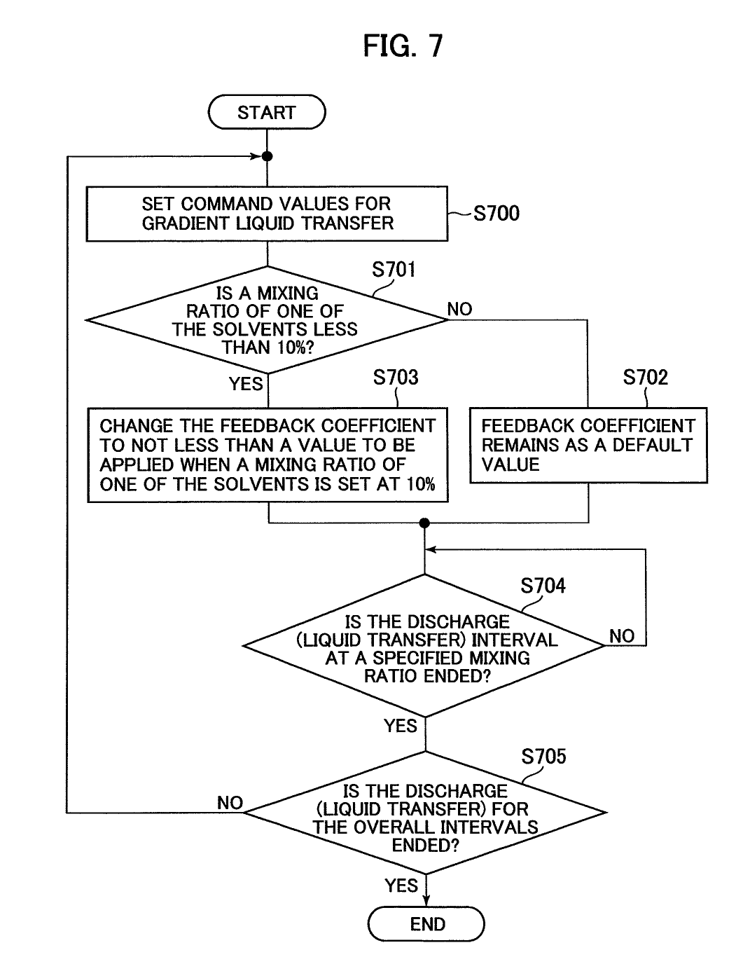

FIG. 7 is an operation flowchart for changing the feedback coefficient according to the second embodiment.

In FIG. 7, the data processing unit 1507 sets command values (the feedback coefficient, etc.) necessary for gradient liquid transfer (step S700). The determining section 1510B or 1511B determines whether or not the mixing ratio of one of the solvents in the gradient liquid transfer operation at a present time is less than 10% (step S701).

In step S701, if the mixing ratio or the gradient ratio is not less than 10%, the operation proceeds to step S702, in which the feedback coefficient is set at a default value [an initial value (a first feedback coefficient) stored in the memory 1512], and the operation proceeds to step S704.

In step S701, if the mixing ratio or the gradient ratio is less than 10%, the operation proceeds to step S703, in which the feedback coefficient is changed to a second feedback coefficient (stored in the memory 1512) greater than the initial value, and the operation proceeds to step S704.

In step S704, the determining section S1510B or 1511B determines whether or not discharge (liquid transfer) for one cycle is ended. If it is determined that the discharge for one cycle is ended, the operation proceeds to step S705.

In step S705, it is determined whether or not the discharge (liquid transfer) for the full cycles is ended. If the discharge for the full cycles is ended, the operation is ended. In step S705, the discharge for the full cycles is not ended, the operation is returned to step S700.

Similarly to the first embodiment, also the second embodiment of the present invention can provide the liquid chromatograph and the high-pressure constant flow rate liquid transfer method for the liquid chromatograph which uses the high-pressure constant flow rate pump that can reliably transfer a solvent from a low-pressure side liquid transfer system even if a difference in mixing ratio is large when solvents are mixed in the high-pressure gradient liquid transfer.

The second embodiment of the present invention is an example in which the transfer of the solvent from the liquid transfer system on the side where the value of the mixing ratio of one of the solvents is small is reliably implemented by changing the feedback coefficient. Therefore, the first pressure sensor 110 and the second pressure sensor 114 can be omitted. However, also in the second embodiment of the present invention, the first pressure sensor 110 and the second pressure sensor 114 can be disposed to monitor the associated pressure values. In this way, it is possible to check whether or not the first check valve 112 and the second check valve 117 are in the opened state.

The other configurations of the second embodiment are the same as those of the first embodiment; therefore, their explanations are omitted.

The relationship between the position of the first plunger 103 and the detected pressure value of the pressure sensor 110 is previously determined depending on when the first check valve 112 is in the opened state and when in the closed state, and is stored in the memory 1512. This because it is considered that the relationship between the position of the first plunger 103 and the detected pressure value of the pressure sensor 110 is different between when the first check valve 112 is in the opened state and when in the closed state. In the actual gradient liquid transfer, the position of the first plunger 103 and the detected pressure value of the pressure sensor 110 are obtained. In addition, the above-mentioned relationship stored in the memory 1512 is referred to. Thus, it is possible to determine whether the first check valve 112 is closed or opened.

Also the relationship among the second check valve 117, the position of the second plunger 116 and the second pressure sensor 114 is the same as the relationship among the above-mentioned first check valve 112, first plunger 103 and first pressure sensor 110.

The above liquid transfer device (the high-pressure constant flow rate pump) 1502 is operatively controlled by the data processing unit 1507 of the liquid chromatograph by way of example. Also the high-pressure constant flow rate pump alone can exist. In this case, the function of the data processing unit shown in FIG. 3 is incorporated in the high-pressure constant flow rate pump.

What is claimed is:

1. A high-pressure constant flow rate pump, comprising:
a first pump for discharging a first solvent;
a second pump for discharging a second solvent;
a mixer for mixing the first solvent discharged from the first pump with the second solvent discharged from the second pump and transferring the mixed solvent;
a first pressure sensor disposed in a passage between the first pump and the mixer, the first pressure sensor detecting a pressure of the first solvent discharged from the first pump;
a first check valve disposed in a passage between the first pressure sensor and the mixer;
a second pressure sensor disposed in a passage between the second pump and the mixer, the second pressure sensor detecting a pressure of the second solvent discharged from the second pump;
a second check valve disposed in a passage between the second pressure sensor and the mixer; and
a control section configured to
control a discharge amount of the first solvent from the first pump and a discharge amount of the second solvent from the second pump to change a mixing ratio of the first solvent and the second solvent in the mixer,
determine whether the first check valve is in an opened or closed state on the basis of a pressure, among others, detected by the first pressure sensor, and if the first check valve is in the closed state, increase the discharge pressure of the first pump to bring the first check valve into the opened state, and
determine whether the second check valve is in an opened or closed state on the basis of a pressure, among others, detected by the second pressure sensor, and if the second check valve is in the closed state, increase the discharge pressure of the second pump to bring the second check valve into the opened state.

2. The high-pressure constant flow rate pump according to claim 1, further comprising:
a third pressure sensor disposed in a passage between the first check valve and the mixer; and
a fourth pressure sensor disposed in a passage between the second check valve and the mixer, wherein
the control section controls the discharge pressure of the first pump or that of the second pump, which pump discharges a solvent having a smaller mixing ratio, so that
the detected pressure value of the first pressure sensor may be equal to or greater in a predetermined range than the detected pressure value of the third pressure sensor, or
the detected pressure value of the second pressure sensor may be equal to or greater in a predetermined range than the detected pressure value of the fourth pressure sensor.

3. The high-pressure constant flow rate pump according to claim 2, further comprising a display section, wherein
the control section determines whether or not the detected pressure value of the first pressure sensor or the second pressure sensor is smaller than the detected pressure value of the third pressure sensor or the forth pressure sensor, respectively,
if the detected pressure value of the first pressure sensor or the second pressure sensor is determined to be smaller than the detected pressure value of the third pressure sensor or the forth pressure sensor, respectively, the control section determines whether or not a first solvent or a second solvent is leaking from the first pump or the second pump on the basis of the driving amount of the first pump or the second pump and an increased value of the pressure value detected by the first pressure sensor or the second pressure sensor, respectively, and
further, if the first solvent or the second solvent is determined to be leaking, the control section allows the display section to indicate that the first solvent or the second solvent is leaking.

4. The high-pressure constant flow rate pump according to claim 3, wherein
if the first solvent or the second solvent is determined to be not leaking from the first pump or the second pump, respectively, the control section identifies the type of the first solvent or the second solvent on the basis of the driving amount of the first pump or the second pump and the pressure value detected by the first pressure sensor or the second pressure sensor, respectively, and then adds a driving amount to the first pump or the second pump in accordance with the type of the solvent thus identified, respectively.

5. The high-pressure constant flow rate pump according to claim 1, wherein
the control section obtains a difference between a pressure value detected by the first pressure sensor or the second pressure sensor and a predetermined reference liquid transfer pressure,
the control section exercises proportional control by which the first pump or the second pump is driven according to a value obtained by multiplying the difference thus obtained by a proportionality coefficient, the proportionality coefficient consisting of a first proportionality coefficient and a second proportionality coefficient,
the first proportionality coefficient is used when the solvent transferred from the first or second pump has a predetermined mixing ratio or greater, and
the second proportionality coefficient is used when the solvent has a mixing ratio less than the predetermined mixing ratio, the second proportionality coefficient being greater than the first proportionality coefficient.

6. A high-pressure constant flow rate liquid transfer method comprising the steps of:
discharging a first solvent from a first pump to a mixer via a first pressure sensor and a first check valve;
discharging a second solvent from a second pump to the mixer via a second pressure sensor and a second check valve;
controlling a discharge amount of the first solvent from the first pump and a discharge amount of the second solvent from the second pump to change a mixing ratio of the first solvent and the second solvent in the mixer;
determining whether the first check valve is in an opened or closed state on the basis of a pressure, among others, detected by the first pressure sensor;
increasing the discharge pressure of the first pump to bring the first check valve into the opened state if the first check valve is in the closed state;
determining whether the second check valve is in an opened or closed state on the basis of a pressure, among others, detected by the second pressure sensor; and
increasing the discharge pressure of the second pump to bring the second check valve into the opened state if the second check valve is in the closed state.

7. The high-pressure constant flow rate liquid transfer method according to claim 6, further comprising the steps of:
disposing a third pressure sensor in a passage between the first check valve and the mixer,
disposing a fourth pressure sensor in a passage between the second check valve and the mixer, and
controlling the discharge pressure of the first pump or that of the second pump, which pump discharges a solvent having a smaller mixing ratio, so that
the detected pressure value of the first pressure sensor may be equal to or greater in a predetermined range than the detected pressure value of the third pressure sensor, or
the detected pressure value of the second pressure sensor may be equal to or greater in a predetermined range than the detected pressure value of the fourth pressure sensor.

8. The high-pressure constant flow rate liquid transfer method according to claim 7, further comprising the steps of;
determining whether or not the detected pressure value of the first pressure or the second pressure sensor is smaller than the detected pressure value of the third pressure or the fourth pressure sensor, respectively,
if the detected pressure value of the first pressure sensor or the second pressure sensor is smaller than the detected pressure value of the third pressure sensor or the fourth pressure sensor, respectively, determining whether or not a first solvent or a second solvent is leaking from the first pump or the second pump on the basis of the driving amount of the first pump or the second pump and an increased value of the pressure value detected by the first pressure sensor or the second pressure sensor, respectively, and
further, if the first solvent or the second solvent is determined to be leaking, allowing the display section to indicate that the first solvent or the second solvent is leaking.

9. The high-pressure constant flow rate liquid transfer method according to claim 8, further comprising the steps of:
if the first solvent or the second solvent is determined not to be leaking from the first pump or the second pump, respectively, identifying the type of the first solvent or the second solvent on the basis of the driving amount of the first pump or the second pump and the detection value of the first pressure sensor or the second pressure sensor and then adding a driving amount to the first pump or the second pump in accordance with the type of the solvent thus identified, respectively.

10. The high-pressure constant flow rate liquid transfer method according to claim 6, further comprising the steps of:
obtaining a difference between a pressure value detected by the first pressure sensor or the second pressure sensor and a predetermined reference liquid transfer pressure, and
exercising proportional control by which the first pump or the second pump is driven according to a value obtained by multiplying the difference thus obtained by a proportionality coefficient, the proportionality coefficient consisting of a first proportionality coefficient and a second proportionality coefficient, the first proportionality coefficient being used when the solvent transferred from the first pump or the second pump is equal to or greater than a predetermined mixing ratio, the second proportionality coefficient being used when the solvent transferred from the first pump or the second pump is less than the predetermined mixing ratio, the second proportionality coefficient being greater than the first proportionality coefficient.

11. A liquid chromatograph comprising:
the high-pressure constant flow rate pump according to claim 1;
a sample pouring section for pouring a sample into a mixed liquid discharged from the high-pressure constant flow rate pump;
a separation column for separating a component from the sample transferred from the sample pouring section;
a detector for detecting the component separated from the separation column; and
a control section for controlling the operation of the sample pouring section and of the detector.

12. The liquid chromatograph according to claim 11, further comprising:
a third pressure sensor disposed in a passage between the first check valve and the mixer; and
a fourth pressure sensor disposed in a passage between the second check valve and the mixer, wherein
the control section controls the discharge pressure of the first pump or that of the second pump, which pump discharges a solvent having a smaller mixing ratio, so that
the detected pressure value of the first pressure sensor may be equal to the detected pressure value of the third pressure sensor, or
the detected pressure value of the second pressure sensor may be equal to the detected pressure value of the fourth pressure sensor.
